(19) United States
(12) Patent Application Publication
(10) Pub. No.: US 2010/0199851 A1
(43) Pub. Date: Aug. 12, 2010

(54) DEVICE FOR TRANSPORTATION OF MILK

(75) Inventors: Sandra aus der Fuenten, Bielefeld (DE); Gerald Aengenheyster, Minden (DE); Nils Krutemeyer, Kirchlengern (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/700,537

(22) Filed: Feb. 4, 2010

(30) Foreign Application Priority Data
Feb. 6, 2009 (DE) 20 2009 001 491.6

(51) Int. Cl. A47J 31/54; A47J 31/00

(52) U.S. Cl. 99/293; 99/302 R

(57) ABSTRACT

A device for transporting milk includes a nozzle coupled via a line to a milk container. A steam generating unit produces hot milk foam at the nozzle. A milk outlet is coupled to the nozzle. A pump to pump cold milk is arranged between the milk container and the milk outlet.

### CROSS-REFERENCE TO RELATED APPLICATION

This application claims the priority of German Patent Application No. DE 20 2009 001 491.6, filed on Feb. 6, 2009, the subject matter of which is incorporated herein by reference.

### BACKGROUND OF THE INVENTION

The present invention relates to a device for transporting milk, in particular used in automatic coffee machines, the device comprising a milk container that is connected via a line to a nozzle, a device for generating hot steam which can be used to generated hot milk foam at the nozzle, as well as a milk outlet.

Systems for transporting milk are known which use a Venturi nozzle to suction up milk from a milk container and then transport it through the Venturi nozzle operated with hot steam. Hot milk foam can thus be generated and the milk can be heated. This system has proven successful for producing hot beverages, but cannot be used for the transport of cold milk.

A device for generating milk foam is known from Swiss Patent document CH 684 627, for which heated milk is pushed under high pressure through a foaming element. In the process, hot milk foam is produced. However, the problem with these types of nozzles is the cleaning, since milk-carrying lines in particular can be contaminated easily.

Automatic beverage dispensers are also known from the hospitality industry, for which a milk container is arranged inside a cooling compartment and milk can be transported with the aid of a pump. Devices of this type, which are intended for the hospitality industry, are comparably expensive and are not intended for use in a household.

### SUMMARY OF THE INVENTION

It is therefore an object of the present invention to provide a device for transporting milk which has a simple design and can also be used in the household area.

The above and other objects are accomplished according to the invention wherein there is provided, according to one embodiment, a device for transporting milk, comprising: a nozzle; a milk container connected via a line to the nozzle; a steam generating unit to produce hot milk foam at the nozzle; a milk outlet coupled to the nozzle; and a pump to pump cold milk arranged between the milk container and the milk outlet.

Thus, according to the invention, the device for transporting milk comprises a milk container that is connected with the aid of a device for generating hot steam, so that hot milk foam and/or hot milk can be produced. The milk container is furthermore connected via a pump for pumping cold milk to the milk outlet, such that the device for transporting milk can be used to transport hot as well as cold milk which may be used for, for example, to produce coffee-based beverages.

During the hot season of the year, cold coffee-based beverages are increasingly consumed as well as hot coffee-based beverages. The device has a simple design because hot or cold milk is optionally pumped from the milk container and the number of components or lines that must be cleaned are limited to a minimum. The milk container and the lines in particular can be configured so that they can be detached and the device can be disassembled easily for cleaning purposes. A separate cooling device for cooling the milk container is not required since the milk container can be emptied and cleaned following the use.

According to one embodiment of the invention, cold or hot milk or milk foam can be selectively dispensed at the milk outlet with the aid of a manual or automatic control. A high degree of flexibility thus results, which allows combining the device for transporting milk with an automatic beverage dispenser, in particular an automatic coffee maker, for household use.

The pump may be arranged between the milk container and the nozzle. As a result, the pump can push the cold milk through the nozzle, wherein this pump can be embodied as peristaltic pump which transports the milk by displacement through a tube (line). As a result, only the line is wetted with milk and only the inside wall of the line must be cleaned after the use. The handling is thus simplified since the line can be cleaned easily by flushing it.

According to a different embodiment of the invention, the nozzle may be a Venturi nozzle so that milk can also be taken in at the Venturi nozzle during the generating of hot steam.

A water tank may be connected to the nozzle with the aid of the device for generating hot steam. In addition, a water pump can be provided for pumping the water out of the water tank, such that the supplied quantity of water in the hot or cold form and/or in the form of hot steam can be metered out easily.

An adjustable air intake opening for taking in ambient air may be provided on the nozzle for a precise adjustment of the consistency of the milk foam in dependence on the milk that is used. As a result, milk foam of high quality can be generated at the nozzle.

### BRIEF DESCRIPTION OF THE DRAWINGS

These and other features and advantages of the invention will be further understood from the following detailed description with reference to the accompanying drawings.

FIG. 1 is an operational sequence diagram for the device according to the invention for transporting milk.

FIG. 2 is a perspective view of the device for transporting milk.

FIG. 3 is an exploded, enlarged representation of the individual components of the device for transporting milk.

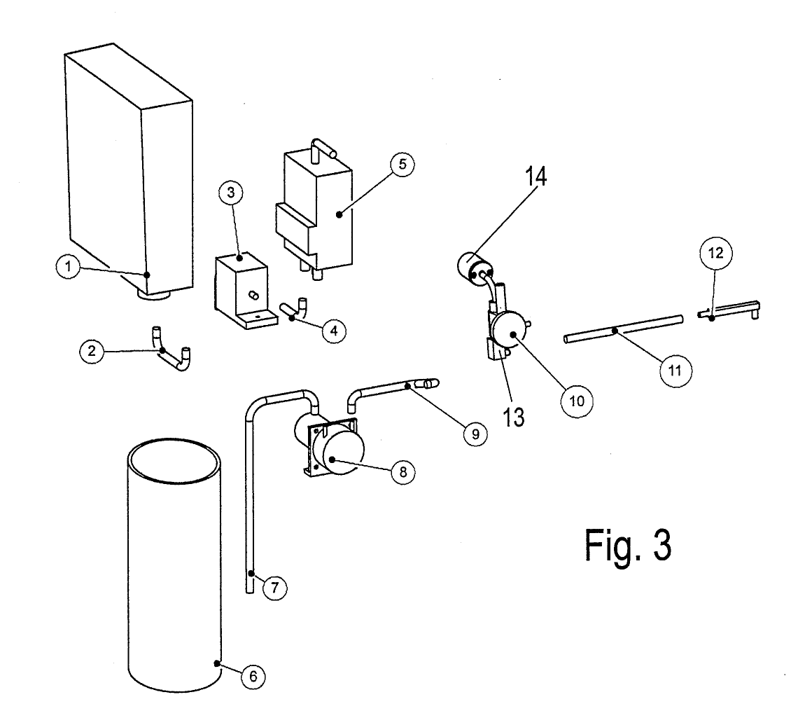

### DETAILED DESCRIPTION

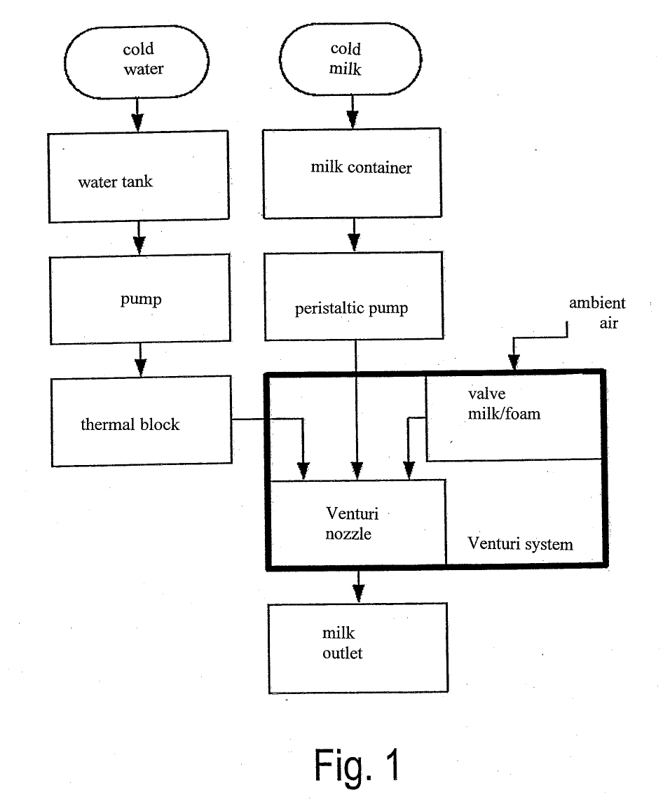

Referring to FIG. 1, there is shown an operational sequence diagram for the device according to the invention for transporting milk. Cold water 20 is pumped with the aid of a pump 24 from a water tank to a thermal unit 26 in which the water can optionally be heated, in particular for generating hot steam. The hot steam is then transported to a nozzle 28, especially a Venturi nozzle.

Cold milk 30 is pumped via a second line to a milk container 32 which is connected via another line to a peristaltic pump 34, wherein the peristaltic pump can transport the cold milk to the nozzle 28.

The nozzle 28 forms a component of a Venturi system 36 which, in addition to the intake of milk and water, can also take in ambient air via a valve 38 and mix the air with the milk and/or water.

Cold or hot water, hot steam, cold milk, hot milk or hot milk foam can therefore be provided to a milk outlet 40 following the Venturi system. A large number of hot or cold beverages can thus be prepared to which milk is added. The device for transporting milk may be combined, in particular, with an automatic coffee maker for the household use.

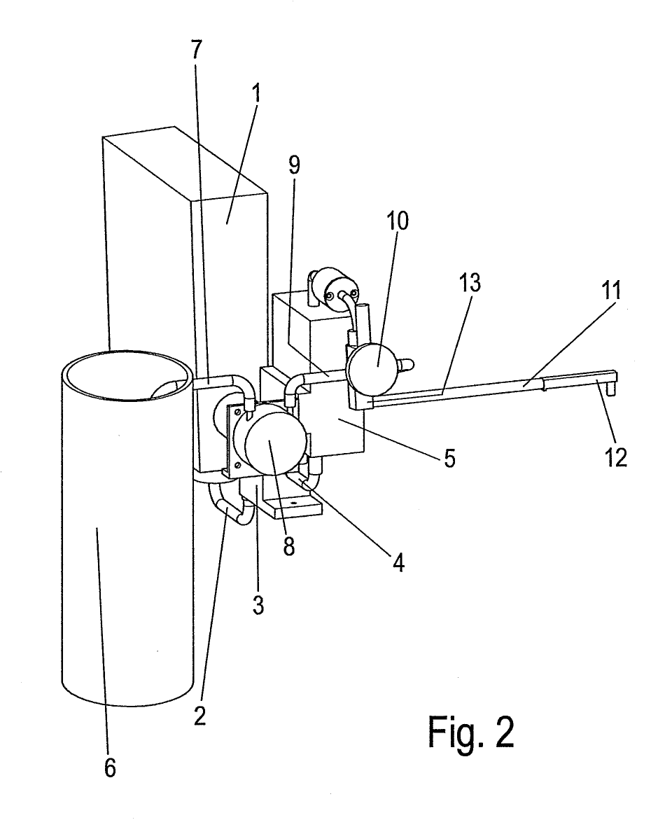

FIG. 2 is a perspective schematic which shows a device for transporting milk in accordance with the operational sequence of FIG. 1. In FIG. 2 there is shown a water tank 1 that is connected via a line 2 to a water pump 3. The water pump 3 can pump cold water from the water tank 1 to a thermal unit 5 which is connected via a line 4 to the water pump 3. Inside the thermal unit 5, the pumped-in water can optionally be heated or processed into hot steam.

A milk container 6 is provided for the transport of milk, wherein the end section of a line 7 is arranged in the bottom region of the milk container. This line is connected outside of the container 6 to a pump 8 for pumping cold milk. The pump 8 is embodied as a peristaltic pump and can thus transport the milk from the container 6 without wetting any components except for the line in which milk is transported. The pump 8 is connected via a line 9 to a Venturi system which comprises a nozzle 13, in particular a Venturi nozzle. From the Venturi system 10, the milk or the milk foam is transported through a line 11 to a milk outlet 12. The nozzle 13 is furthermore connected via a coupling element 14 to the thermal unit 5.

If the device for transporting milk is used for an automatic coffee machine, then the water tank 1, the pump 8 for pumping cold milk, the water pump 3 and the Venturi system 10 are arranged on the automatic coffee machine. The milk container 6 may be mounted loosely next to the automatic coffee machine on the line 7, so that it can be cleaned easily. The lines 7, 9 and 11 are cleaned by pumping a cleaning fluid through the lines 7, 9 and 11.

The device according to the invention for transporting milk can thus be used to transport cold or hot milk to the milk outlet 12. Milk foam can furthermore also be produced at the Venturi nozzle 13, wherein an adjustable air intake opening is provided at the Venturi nozzle 13 for metering in the supplied ambient air.

It will be understood that the above description of the present invention is susceptible to various modifications, changes and adaptations, and the same are intended to be comprehended within the meaning and range of equivalents of the appended claims.

What is claimed is:

1. A device for transporting milk, comprising:
a nozzle;
a milk container connected via a line to the nozzle;
a steam generating unit to produce hot milk foam at the nozzle;
a milk outlet coupled to the nozzle; and
a pump to pump cold milk arranged between the milk container and the milk outlet.

2. The device according to claim 1, further including a manual or an automatic control to selectively dispense cold or hot milk or milk foam at the milk outlet.

3. The device according to claim 1, wherein the pump is arranged between the milk container and the nozzle.

4. The device according to claim 1, wherein the pump comprises a peristaltic pump to transport the milk through displacement inside a line coupled to the milk outlet.

5. The device according to claim 1, wherein the nozzle comprises a Venturi nozzle.

6. The device according to claim 1, further comprising a water tank connected via the steam generating unit to the nozzle.

7. The device according to claim 6, further comprising a water pump arranged to pump water from the water tank.

8. The device according to claim 1, further including an adjustable air intake opening at the nozzle for intake of ambient air.
